(19) United States
(12) Patent Application Publication
(10) Pub. No.: US 2002/0136876 A1
(43) Pub. Date: Sep. 26, 2002

(54) Method and means for advertising

(76) Inventor: Todd R. Calfee, Bennet, NE (US)

Correspondence Address: THOMTE, MAZOUR & NIEBERGALL, L.L.C., 2120 S. 72ND STREET, SUITE 1111, OMAHA, NE, 68124, US

(21) Appl. No.: 09/812,526

(22) Filed: Mar. 20, 2001

(51) Int. Cl. B32B 7/02; B32B 27/14

(52) U.S. Cl. 428/212; 428/195

(57) ABSTRACT

A method and means for advertising at an athletic event is disclosed. A transferable media in the form of a temporary tattoo is provided wherein a company name and/or logo is closely associated with a team name, logo and/or nickname. The temporary tattoo is transferred from its carrier sheet to the skin of a cheerleader, dance squad member, or player.

### BACKGROUND OF THE INVENTION

1. Field of the Invention

This invention relates to a method and means for advertising and more particularly to a method and means for advertising at an athletic event such as a baseball game, football game, basketball game, etc.

2. Description of the Related Art

Many types of advertising are utilized at sporting or athletic events such as baseball games, football games, basketball games, etc. Normally, the advertisements appear on banners, signs, etc. During some athletic events, such as football games where cheerleaders or dance squads perform, the performers are scantily clad with exposed abdomens, thighs, etc. The performers normally wear clothing upon which the logos of their athletic team appear. Much attention is normally directed to those performers, especially the male ticket holders. It has been determined that the performers could serve as a moving advertisement if company names and/or logos could appear on the performers, and especially if those company names and/or logos appeared on the exposed skin of the performers. It has been also determined that the advertisements or advertising message would be very effective if they are closely associated with the team logo, name or nickname.

### SUMMARY OF THE INVENTION

A method and means for advertising is disclosed which involves the use of a transferable media in the form of a temporary tattoo which is applied to the exposed skin of a cheerleader or dance squad member at an athletic event. The tattoo not only includes the name or logo of one of the participating teams in the athletic event, but also includes the name and/or logo of a company who wishes to advertise. In one form of the invention, the team name and/or logo is split into two or more logo segments. The company name and/or logo is positioned between the logo portions. Thus, a fan attending the athletic event will frequently pay particular attention to the cheerleaders or dance squad members and will observe the company name and/or logo appearing on the exposed skin of the cheerleaders and/or dance squad members. Further, the advertisements or advertising message could be placed on the exposed skin of the players.

It is therefore a principal object of the invention to provide a novel method and means for advertising.

Still another object of the invention is to provide a novel method and means for advertising at an athletic event.

Still another object of the invention is to provide a novel method and means for advertising wherein a company name and/or logo is closely associated the team name, logo and/or nickname.

Still another object of the invention is to provide a novel method and means for advertising through the use of a temporary tattoo which has a company name and/or logo associated with an athletic team logo, name or nickname.

These and other objects will be apparent to those skilled in the art.

### BRIEF DESCRIPTION OF THE DRAWINGS

FIG. 1 is a perspective view of a cheerleader or dance squad member having the graphic of this invention appearing thereon;

FIG. 2 is a plan view of the transferable media (temporary tattoo) of this invention; and

FIG. 3 is an end view of the temporary tattoo of this invention illustrating the protective film or cover being removed therefrom.

### DESCRIPTION OF THE PREFERRED EMBODIMENT

In the drawings, the numeral 10 generally designates a cheerleader or dance squad member who would normally perform at an athletic event such as a baseball game, a football game, a basketball game, etc. Most cheerleaders and dance squad members have a large amount of exposed skin. For the purposes of description, the person 10 will be described as having an abdominal skin area 12 which is exposed between a top 14 and a bottom 16.

The transferable media of this invention is generally designated by the reference numeral 18 and is what is commonly referred to as a temporary tattoo. Transferable media 18 includes a carrier sheet 20 having a bottom surface 22 and a top surface 24. An adhesive is normally applied to the top surface 24 in customary fashion. A tattoo 26 is positioned upon the top surface 24 of media 18 and is removably held thereon by the adhesive on the top surface 24. A transparent, flexible cover or protective sheet 28 is positioned over tattoo 26 and carrier sheet 20 in conventional fashion.

The construction of the media 18 is conventional except for the arrangement and/or design of the tattoo 26 and the use thereof for advertising purposes. Tattoo 26 preferably includes the logo 30 of one of the teams participating in the athletic event such as the Lincoln Lightning™. The logo 30 is preferably split or divided into two or more parts which, for purposes of description, are designated as logo portions 30A and 30B. Normally, logo portions 30A and 30B would be contiguous with each other.

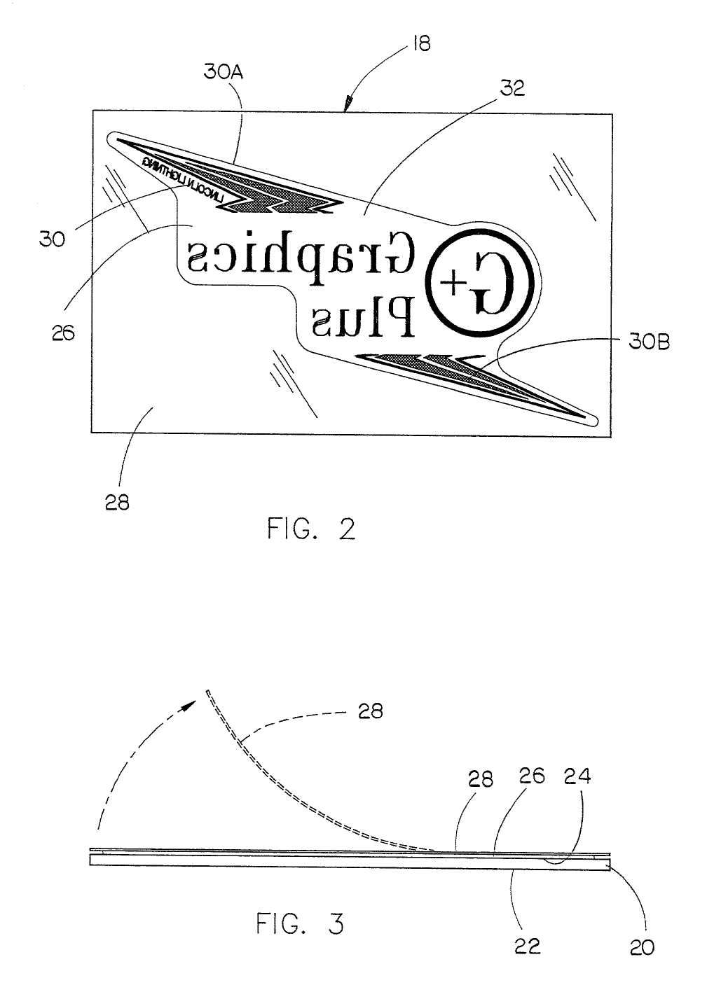

In order for a company to draw attention to itself, the name and/or logo of the company is positioned between the logo portions 30A and 30B, as seen in FIG. 2, and which is referred to by the reference numeral 32 in FIG. 2. Although it is preferred that the company name and/or logo 32 be positioned between the logo portions 30A and 30B, as seen in FIG. 2, the company name and/or logo 32 could be closely positioned adjacent the top, bottom, or at either side of the logo 30.

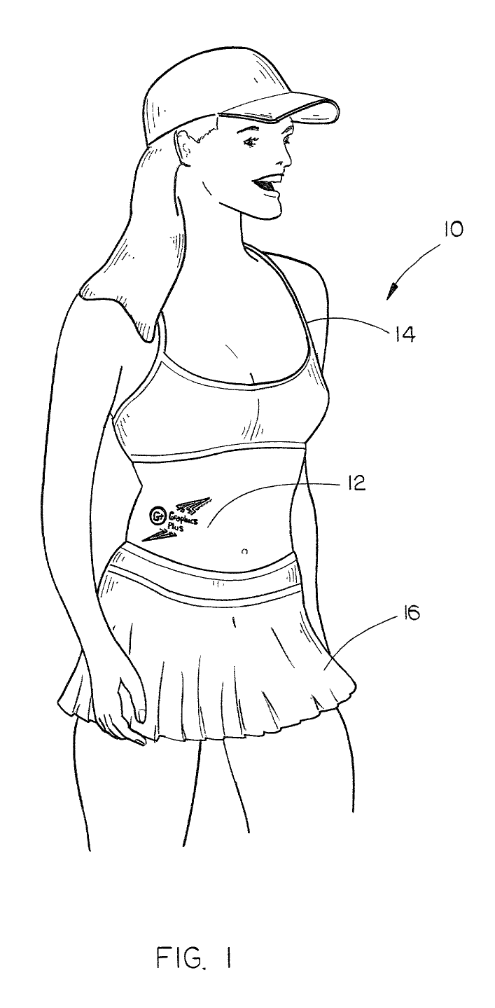

When a particular company, such as Graphics Plus™ desires to advertising, the media is produced. The protective cover or sheet 28 is removed to expose the tattoo 26. The carrier sheet 20 is normally wetted and the tattoo is placed adjacent the skin of the cheerleader and/or dance squad member 10, as seen in FIG. 1. The tattoo may also be placed on any exposed skin of the cheerleader and/or dance squad member although the abdomen is the preferred location for the tattoo. When the tattoo has adhered to the skin of the performer, the carrier sheet 20 is removed therefrom.

Thus, when the tattoo has been applied to the skin of the performer, the attention of the fans attending the athletic event, as well as television viewers, is drawn to the tattoos on the performers. The viewers will not only observe the team logo, name and/or nickname, but will observe the company name seeking to advertise such as, in this case, Graphics Plus. It should be noted that the tattoo could also be placed on the exposed skin of the players participating in the athletic event.

Thus it can be seen that the invention accomplishes at least all of its stated objectives.

I claim:

1. A method of advertising, comprising the steps of:
(a) providing a logo owned by a particular entity;
(b) combining an advertisement with said logo to create a combined graphic wherein said logo and said advertisement appear together; and
(c) placing the combined graphic on the skin surface of a person who will display said graphic.

2. The method of claim 1 wherein said combined graphic is placed on the abdomen of the person.

3. The method of claim 1 wherein said graphic is constructed of a transferable media.

4. The method of claim 3 wherein said transferable media comprises a temporary tattoo.

5. The method of claim 1 wherein said advertisement comprises a company name.

6. The method of claim 1 wherein said logo comprises an athletic logo.

7. The method of claim 1 wherein said logo is divided into at least two spaced-apart portions and wherein said advertisement is positioned between said two spaced-apart portions.

8. The method of claim 1 wherein said logo and said advertisement are owned by different entities.

9. A transferable media, comprising:
a backing sheet having a top surface and a bottom surface;
a temporary tattoo positioned on said top surface of said backing sheet; and
a protective sheet removably positioned over said tattoo;
said tattoo comprising a combined logo and advertisement.

10. The transferable media of claim 9 wherein said logo is divided into at least two spaced-apart portions and wherein said advertisement is positioned between said two spaced-apart portions.

11. The transferable media of claim 9 wherein said advertisement comprises company name.

12. The transferable media of claim 9 wherein logo comprises an athletic logo.

13. The transferable media of claim 9 wherein said logo and said advertisement are owned by different entities.

14. A method of advertising, at an athletic event, comprising the steps of:
(a) providing a logo owned by a particular entity;
(b) combining an advertisement with said logo to create a combined graphic wherein said logo and said advertisement appear together; and
(c) placing the combined graphic on the skin surface of a cheerleader at the athletic event.

15. The method of claim 14 wherein said combined graphic is placed on the abdomen of the cheerleader.

16. The method of claim 14 wherein said graphic is constructed of a transferable media.

17. The method of claim 14 wherein said transferable media comprises a temporary tattoo.

18. The method of claim 14 wherein said advertisement comprises a company name.

19. The method of claim 14 wherein said logo comprises an athletic logo.

20. The method of claim 14 wherein said logo is divided into at least two spaced-apart portions and wherein said advertisement is positioned between said two spaced-apart portions.

21. The method of claim 14 wherein said logo and said advertisement are owned by different entities.

22. A method of advertising, at an athletic event, comprising the steps of:
(a) providing a logo owned by a particular entity;
(b) combining an advertisement with said logo to create a combined graphic wherein said logo and said advertisement appear together; and
(c) placing the combined graphic on the skin surface of a dancer at the athletic event.

23. The method of claim 22 wherein said combined graphic is placed on the abdomen of the dancer.

24. The method of claim 22 wherein said graphic is constructed of a transferable media.

25. The method of claim 22 wherein said transferable media comprises a temporary tattoo.

26. The method of claim 22 wherein said advertisement comprises a company name.

27. The method of claim 22 wherein said logo comprises an athletic logo.

28. The method of claim 22 wherein said logo is divided into at least two spaced-apart portions and wherein said advertisement is positioned between said two spaced-apart portions.

29. The method of claim 22 wherein said logo and said advertisement are owned by different entities.

30. A method of advertising, at an athletic event, comprising the steps of:
(a) providing a logo owned by a particular entity;
(b) combining an advertisement with said logo to create a combined graphic wherein said logo and said advertisement appear together; and
(c) placing the combined graphic on the skin surface of a player at the athletic event.

31. The method of claim 30 wherein said graphic is constructed of a transferable media.

32. The method of claim 30 wherein said transferable media comprises a temporary tattoo.

33. The method of claim 30 wherein said advertisement comprises a company name.

34. The method of claim 30 wherein said logo comprises an athletic logo.

35. The method of claim 30 wherein said logo is divided into at least two spaced-apart portions and wherein said advertisement is positioned between said two spaced-apart portions.

36. The method of claim 30 wherein said logo and said advertisement are owned by different entities.
